(19) United States
(12) Patent Application Publication
(10) Pub. No.: US 2006/0237206 A1
(43) Pub. Date: Oct. 26, 2006

(54) Percussion power tool

(75) Inventors: Michael Schamberger, Scheuring (DE); Erwin Manschitz, Germering (DE); Christian Daubner, Mammendorf (DE); Josef Bauer, Landsberg am Lech (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/373,785

(22) Filed: Mar. 9, 2006

(30) Foreign Application Priority Data
Apr. 25, 2005 (DE) 10 2005 000 042.8

(51) Int. Cl. B25D 11/00

(52) U.S. Cl. 173/201; 173/128

(57) ABSTRACT

A percussion mechanism (21; 41) for a percussion power tool includes an impact element (24; 44) reciprocating along a percussion axis (22; 42) of the percussion mechanism (21; 41) and acting on the striker (26, 46). The contact point (27, 47) and counter-contact point (28, 48) are provided between the striker (26, 46) and the impact element (24, 44), with the contact point (27, 47) being formed as an exposed contact point and being arranged outside of the percussion axis (22; 42).

### BACKGROUND OF THE INVENTION

1. Field of the Invention

The present invention relates to a hammer drill or a chisel hammer with a percussion mechanism including a striker and an impact element reciprocating along a percussion axis of the percussion mechanism and acting on the striker, with the striker and the impact element having cooperating contact point and counter-contact point.

2. Description of the Prior Art

In hammer drills or chisel hammers with a percussion mechanism, blow or impact pulses are transmitted to a shank of a working tool, which is received in a tool holder of the percussion power tool, by a striker which sometimes is also called an anvil and which is acted upon by an impact element reciprocating along a percussion axis, with the striker and the impact element having cooperating contact point and counter-contact point.

When, e.g., the impact element is formed as a motor-driven driving piston that applies a blow or an impact directly to the end of the striker adjacent to the driving piston for transmitting a blow pulse, the contact point and the counter-contact point contact each other.

German Publication DE 31 21 616 A1 discloses a percussion mechanism with a pneumatically driven percussion piston. The motor-driven driving piston and the percussion piston which sometimes is called a floating or free-moving piston, are both arranged in a guide tube, and an air cushion is formed between the driving piston and the percussion piston. The reciprocating movement of the driving piston causes a phase-shifted reciprocating movement of the percussion piston that acts on the striker, whereby the contact point and the counter-contact point come into contact. When the reciprocating movement of the driving piston is effected using an electric motor, the percussion mechanism is called an electropneumatic percussion mechanism. There is available a large number of electropneumatic percussion mechanisms which find application in hammer drills or chisel hammers with different power levels.

The drawback of the German reference DE 31 21 616 A1 consists in that in case of a breakdown of the working tool in the construction component or when the working tool is lifted off the constructional component, both the percussion piston and the striker are subjected to secondary impacts. It should be noted that during an active operational condition of the hammer drill or the chisel hammer, when the working tool is in contact with the constructional component, the return path of the percussion piston and the striker is short, whereas in the passive operational condition of the hammer drill or the chisel hammer, when the working tool is broken by the constructional component or is lifted off the constructional component, the return path of the striker and the percussion piston in the guide tube can exceed the return path during the active operational condition in twenty (20) times.

In order to avoid the secondary impacts and, thus, to prevent or at least to reduce their influence on the working tool received in the hammer drill or the drill hammer when a pneumatic percussion mechanism is used, there is provided an idle path at least for the percussion piston and the striker. To this end in DE 31 21 616 A1, aeration openings are provided in the guide tube. When the working tool, e.g., is lifted off the constructional component, the sealing means, which are provided on the percussion piston, crosses the aeration opening, and an air cushion is formed between the percussion piston and the driving piston. As a result, no further impacts or blows are applied to the working tool.

Hammer drills or chisel hammers having an increased power are generally subjected to stronger secondary impacts that the power tools with a reduced power. Therefore, in hammer drills and chisel hammers with a high single blow energy, in order to prevent a secondary impact, a relatively longer idle path need be provided. This, in turn, results in a longer hammer drill or chisel hammer which is highly undesirable for ergonomical reasons, e.g., because of an increased weight and/or difficult handling of such hammer drills or chisel hammers.

In addition to the aeration openings, the kinetic energy of the impact element, of the striker, and of the working tool is reduced as a result of friction of these parts in their guides. Ideally, their energy is reduced to such an extent that these parts or components do not displace the percussion piston from its “parking” position in which the air cushion is vented and the aeration openings are closed. As it was explained previously, for constructional and ergonomical reasons, there is no adequate way to reduce the kinetic energy by friction.

When an impact energy of a single blow produced by a hammer drill or chisel hammer is very high, additional and constructively expensive measures such as, e.g., provision of a brake for the striker or of arresting device in the percussion mechanism should be undertaken in order to prevent secondary impacts. Thus, German Publication DE 12 83 769 A1 discloses a striker blade which includes a yieldable clamping ring for holding the striker in its idle position in the passive operational condition of the power tool.

The drawback of this solution consists in a complex construction of such brakes which, e.g., because of their soiling or wear, can easily fail, which noticeably reduce the service life of a hammer drill or chisel hammer.

Accordingly, an object of the present invention is to provide a percussion power tool, in particular, such as a hammer drill or drill hammer, having a percussion mechanism and in which a secondary impact of the striker, the impact element and, thus, of the working tool is prevented by constructively simple and cost-effective means even at a high energy of a single impact or blow of the hammer drill or chisel hammer.

### SUMMARY OF THE INVENTION

This and other objects of the present invention, which will become apparent hereinafter, are achieved by providing an exposed contact point that is arranged outside of the percussion axis.

With a contact point that spatially is the nearest point associated with the counter-contact point and that is arrange eccentrically, during an operation of a hammer drill or chisel hammer, transverse forces, which act on the impact element and the striker, increase friction between the guide and these parts. This friction is noticeably greater than with a centrally arranged contact point. Because of different return paths of the striker and the impact element in the active operational condition and the passive operational condition, the pulse transmission and, thus, the operating efficiency of the hammer drill or chisel hammer is influenced only slightly, despite the eccentric arrangement of the contact point.

With the exposed and eccentric contact point, even with a relatively short idle path, secondary impacts can be prevented even when a hammer drill or chisel hammer with a higher power level is used. The hammer drill or chisel hammer can be made shorter and would have a comparatively smaller weight. Even upon wear in the guides of the striker and/or of the impact element, the function of these parts and, thus, the increased service life of the hammer drill or chisel hammer can be insured by simple constructive measures. The solution according to the present invention is very cost-effective as no additional components or costly operational steps are needed for its realization.

Advantageously, in the inventive percussion mechanism, for venting the air cushion in the passive operational condition of the power tool, aeration opening are provided in the guide tube.

In this context, it should be pointed out that contact point and counter-contact point are not points in a mathematical sense. Rather, they should be understood as representing contact regions corresponding to surfaces which are formed upon encounter of the striker with the impact element. An eccentric arrangement or an offset arrangement of the contact point relative to the percussion axis with reference to the middle point should be understood as an arrangement with which the distance to the percussion axis is greater than conventional manufacturing tolerances. It is also conceivable that the percussion axis may extend through the region of the contact point, i.e., a portion of the contact surface of the impact element with the striker.

According to an advantageous embodiment of the percussion power tool, the hammer drill or chisel hammer, the contact point is provided on end of the striker adjacent to the impact element. For forming the contact point, the striker has, e.g., at its end adjacent to the impact element, a convex elevation adjacent to the impact element, the culmination point of which projects from a plane in which the circumferential edge of the striker is located, and is located outside of the percussion axis. The elevation can be, e.g., formed as a parabolical curvature of a first approximation. Alternatively, the contact point can be formed as a body projecting from the plane in which the circumferential edge of the striker is located, e.g., in form of a cylindrical section.

According to another advantageous embodiment of the hammer drill or drill hammer, the contact point is provided on the impact element, on its side adjacent to the striker. For forming the contact point, the impact element has, e.g., on its side adjacent to the striker, a convex elevation adjacent to the striker, the culmination point of which projects from a plane in which the adjacent side of the impact element is located, and is located outside of the percussion axis. The elevation can have any arbitrary shape, e.g., it can be formed as a parabolic curvature of the first approximation or as a projecting cuboid section.

Also, not only the contact point can be exposed and arranged outside of the percussion axis but also the counter-contact point. However, the shape of the counter-contact point need not necessarily correspond to the shape of the contact point.

Preferably, the contact point is spaced from the percussion axis by a distance that corresponding to an axial length of the striker times 0.003-0.05. This distance insures an increased friction between the impact element or the striker and a corresponding guide in comparison with friction produced in the percussion mechanism with a central impact of the impact element on the striker, and the increased friction reduces the kinetic energy. A distance corresponding to an axial length of the striker times 0.005-0.03 proved to be particularly advantageous for achieving an optimal relationship between the obtained reduction of the kinetic energy, impairment to pulse transmission, and wear of the guides.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional side view of a front region of a percussion power tool with an inventive percussion mechanism according to the first embodiment of the invention;

FIG. 1A a cut-out view showing region IA in FIG. 1 at an enlarged, in comparison with FIG. 1, scale;

FIG. 2 a side view of a striker of the percussion mechanism according to the present invention; and

FIG. 3 a cross-sectional side view of a front region of a percussion power tool with an inventive percussion mechanism according to the second embodiment of the invention.

### DETAILED DESCRIPTION OF THE PREFERRED EMBODIMENT

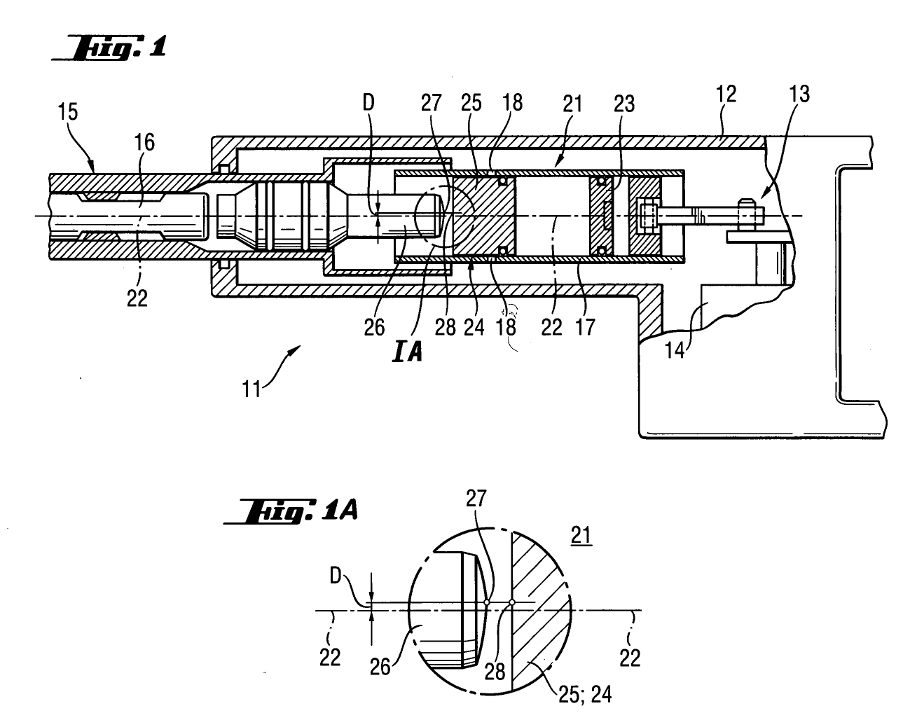

A chisel hammer 11 according to the present invention, which is shown in FIGS. 1 and 1A, includes a housing 12 in which an electro-pneumatic percussion mechanism 21 and a motor transmission unit 14 are arranged. At the front end of the housing 12, there is provided a tool holder 15 in which a shank 16 of a working tool, not shown, such as, e.g., a spade-shaped chisel is received. The percussion mechanism 21 includes a driving piston 23 reciprocates along a percussion axis 22 in a guide tube 17 by an eccentric device 13 which is driven by the motor-transmission unit 14. Reciprocation movement of the driving piston 23 causes phase-shifted reciprocating movement of a percussion piston 25 that serves as impact element 24. The percussion piston 25 acts on a striker 26 having an exposed contact point 27 located above the percussion axis 22. The percussion piston 25 has a counter-contact point 28 that cooperates with the contact point 27 of the striker. The striker 26 transmits a pulse, which is generated by the percussion mechanism 21, to the shank 16 of the working tool. The guide tube 17 is provided with aeration opening 18 for venting an air cushion between the driving piston 23 and the percussion piston 25.

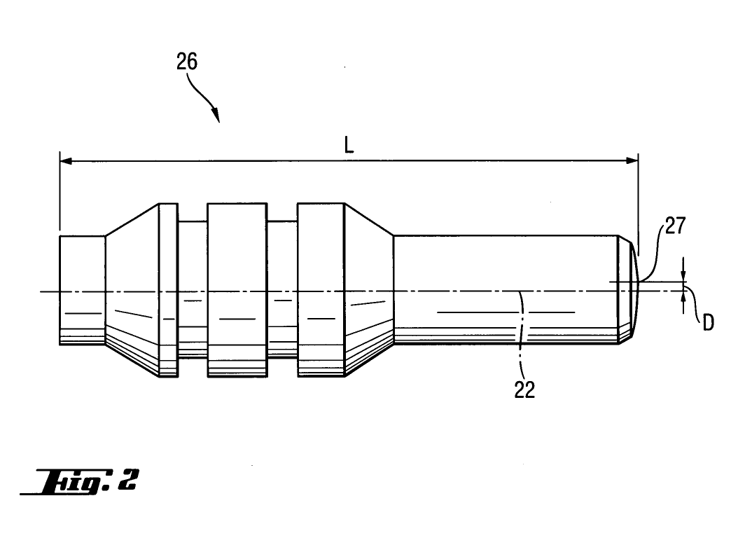

As particularly shown in FIG. 2, the contact point 27 of the striker 26 is spaced from the percussion axis 22 by a distance D that corresponds to 0.02 of the axial length of the striker 26. With a length of the striker 26 of, e.g., 100 mm, the distance D would amount to 2 mm.

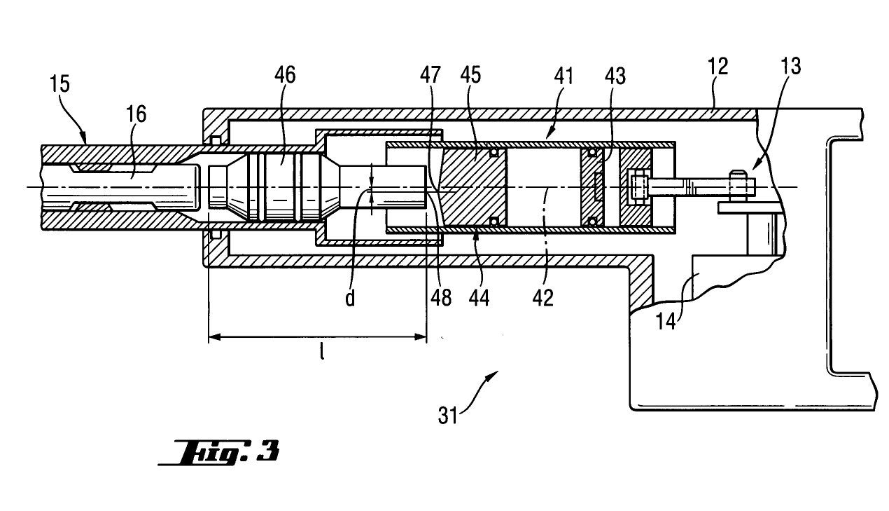

A chisel hammer 31, which is shown in FIG. 3 is substantially analogous to the chisel hammer 11 and differs from it only in the form of the percussion mechanism 41. Contrary to the percussion mechanism 21, in the percussion mechanism 41, it is the percussion piston 45, which is driven by the driving piston 43, and serves as impact element 44, acting on the striker 46, has on its side adjacent to the striker 46 an exposed contact point 47 that cooperates with a counter-contact point 48 provided on the striker 46. The contact point 47 is located outside of the axis 42 and is spaced therefrom by a distance d corresponding to 0.03 of the axial length 1 of the striker 46. With the axial length 1 of the striker 46 of, e.g., 80 mm, the distance of would amount to 2.4 mm.

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A percussion mechanism (21; 41) for a percussion power tool, comprising a striker (26; 46); and impact means (24; 44) reciprocating along a percussion axis (22; 42) of the percussion mechanism (21; 41) and acting on the striker (26, 46) wherein contact point (27, 47) and counter-contact point (28, 48) are provided between the striker (26, 46) and the impact means (24, 44), and wherein the contact point (27, 47) is formed as an exposed contact point and is arranged outside of the percussion axis (22, 42).

2. A percussion mechanism according to claim 1, wherein the contact point (27) is provided on an end of the striker (26) adjacent to the impact means (24).

3. A percussion mechanism according to claim 1, wherein the contact point (47) is provided on an end of the impact means (44) adjacent to the striker (46).

4. A percussion mechanism according to claim 1, wherein the contact point (27; 47) is spaced from the percussion axis (22, 42) by a distance (D; d) corresponding to from 0.003 to 0.05 of an axial length (L; l) of the striker (26; 46).

5. A percussion mechanism according to claim 4, wherein the contact point (27; 47) is spaced from the percussion axis (22, 42) by a distance (D; d) corresponding to from 0.005 to 0.03 of an axial length (L; l) of the striker (26; 46).

6. A percussion power tool, comprising a tool holder (15) for receiving a shank (16) of a working tool; and a percussion mechanism (21; 41) including a striker (26; 46) for applying blows to the shank (16) receivable in the tool holder (15); and impact means (24; 44) reciprocating along a percussion axis (22; 42) of the percussion mechanism (21; 41) and acting on the striker (26, 46), wherein contact point (27, 47) and counter-contact point (28, 48) are provide between the striker (26, 46) and the impact means (24, 44), and wherein the contact point (27, 47) is formed as an exposed contact point and is arranged outside of the percussion axis (22; 42).
